(19) United States
(12) Patent Application Publication
(10) Pub. No.: US 2010/0105331 A1
(43) Pub. Date: Apr. 29, 2010

(54) AUDIO INTERRUPT SYSTEM

(75) Inventors: William S. Buehler, Zeeland, MI (US); Steve Post, Holland, MI (US); Harry G. Derks, Holland, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: FLEETWOOD GROUP, INC., Holland, MI (US)

(21) Appl. No.: 12/534,316

(22) Filed: Aug. 3, 2009

Related U.S. Application Data
(60) Provisional application No. 61/107,770, filed on Oct. 23, 2008.

(51) Int. Cl. H04B 7/005; H04B 5/00

(52) U.S. Cl. 455/41.3; 381/79

(57) ABSTRACT

An audio interrupt system includes multiple audio players—such as a computer, compact disc player, cassette player, stereo, cell-phone, or MP3 player—that generate electrical audio signals and transmit the electrical audio signals to an associated transducer—such as a headphone or a speaker—that converts the electrical audio signals into aural signals that may be heard by a listener. Multiple audio controllers are provided that alter the transmission of the electrical audio signals from at least one of the audio players to the audio player's associate transducer. A hub transmits a control signal to the audio controllers that causes the audio controllers to alter the transmission of the electrical audio signals from the audio players to the associated transducer. The alteration may involve terminating the electrical audio signals or reducing an amplitude of them.

### CROSS-REFERENCE TO RELATED APPLICATIONS

This application claims priority to U.S. provisional patent application Ser. No. 61/107,770 filed Oct. 23, 2008 by applicants William S. Buehler, et al., and entitled Audio Interrupt System, the complete disclosure of which is hereby incorporated herein by reference.

### BACKGROUND OF THE INVENTION

The present invention relates to a communication system for communicating aurally with one or more persons who may be listening to music, wearing noise-cancellation headphones, or engaged in some other activity that is not readily conducive to detecting aural communications.

In many environments, it is customary for individuals to listen to music on headphones or through speakers. For example, many workplace environments allow employees to listen to music while working. Such workplace music-listening typically is limited to the use of headphones so that one employee's music does not disturb other employees, although some workplaces may allow one or more employees to listen to music that is emitted from speakers. Alternatively, in some situations one or more employees may wear noise cancelling headphones while working in order to reduce background noises. The use of headphone and speakers—whether for music, speech, noise-cancelation, or other purposes—typically limits the ability of the listener to detect and respond to other aural sounds, such as verbal communications from a loudspeaker, a telephone, a co-worker, a public address system, a paging system, etc.

### SUMMARY OF THE INVENTION

Accordingly, the present invention provides a method and system for helping to overcome the challenge of communicating with people who are currently listening to sound signals that tend to render aural communication with them difficult. The various aspects of the invention provide an audio interrupt system that interrupts the sound signals—such as by muting, reducing the volume, playing an alternate audio stream, etc.—when it is desired to aurally communicate with the people who are listening to those sounds. Thus, the various aspects of the present invention allow individuals to wear headphones or listen to speaker-produced sound signals without the fear of missing important audio information that they might otherwise have missed. The methods and systems may be applied in the workplace, or in other environments.

According to one aspect of the invention, an audio interrupt system is provided that includes a plurality of audio players, a plurality of audio controllers, and a hub. The audio players are each adapted to generate and/or transmit electrical audio signals to an associated transducer adapted to convert the electrical audio signal to an aural signal that may be heard by a listener. Each of the audio controllers is adapted to alter the transmission of the electrical audio signals from at least one of the audio players to the audio player's associated transducer. The hub is adapted to transmit a control signal or message to the audio controllers whereby the control signal or message causes the audio controllers to alter the transmission of the electrical audio signals from the audio players to their associated transducers.

According to another aspect, an audio interrupt unit is provided. The audio interrupt unit is adapted to operate in conjunction with an audio player wherein the audio player generates an electrical audio signal for transmission to an audio transducer adapted to convert the electrical audio signal into an aural signal. The audio interrupt unit includes a receiver and an audio controller. The receiver is adapted to receive a control signal containing an address. The audio controller, which is in communication with the receiver, is adapted to change the aural signal in response to the control signal if the address of the control signal matches a particular address, and the audio controller is further adapted to not change the aural signal if the control signal does not match the particular address.

According to another aspect, one or more methods are provided for implementing the audio interrupt system and audio interrupt units.

According to still other aspects of the invention, the audio player may be a computer, a compact disc player, a portable media player, a cassette player, a stereo, a cell phone, or other device adapted to deliver audio signals to a user. The transducer may be a stand-alone speaker or a speaker positioned within a headphone. The audio player may include an audio storage unit that may be an electronic memory, a compact disc, an audio cassette, a record, a digital versatile disc (DVD), a buffer for processing streaming audio signals, or other storage medium. The altering of the transmission of the electrical audio signals may include terminating the electrical audio signals, reducing the amplitude of the audio signals, playing alternate signals, or other modifications. The hub may include multiple antennas positioned at different locations within a work environment that allow the hub to transmit the control signals wirelessly. The hub may also, or alternatively, send the control signal over a computer network. The one or more computers responding to the control signal may mute a sound card on the computer, play an alternate audio clip, provide an on-screen notification to the computer user, or transmit a telephonic audio signal to the computer user. The hub may also transmit a plurality of different types of control signals that cause the audio controllers to react in different manners. The audio controllers may also transmit messages back to the hub. The audio controllers may include a plug for inserting into an earphone socket on the audio player, a wireless receiver for receiving the control signal from the hub, an earphone socket for receiving an earphone plug from one or more headphones, and a control for electrically coupling and decoupling the earphone socket to the plug based on the control signal. Alternatively, the plug may be adapted for inserting into a socket on the audio player other than the earphone socket, such as a socket that allows control of the audio player to be effected via the socket. Such control sockets are common on iPods® and other audio players. In still other embodiments, the audio controller may be built into the headphone set.

### BRIEF DESCRIPTION OF THE DRAWINGS

FIG. 1 is a schematic diagram of an audio interrupt system according to a first embodiment;

FIG. 2 is a schematic diagram of an alternative audio interrupt system having a hardware implemented subsystem;

FIG. 3 is a schematic diagram of an alternative audio interrupt system having a software implemented subsystem;

FIG. 4 is a schematic diagram of an illustrative example of a primarily hardware-implemented audio interrupt subsystem;

FIG. 5 is a schematic diagram of a portable audio controller that may be used with the hardware-implemented subsystem of FIG. 4;

FIG. 6 is a schematic diagram of an illustrative example of a primarily software-implemented audio interrupt subsystem;

FIG. 7 is a flowchart illustrating steps that may be followed by a server computer in the diagram of FIG. 6; and

FIG. 8 is a flowchart illustrating steps that may be followed by a remote computer in the diagram of FIG. 6.

### DETAILED DESCRIPTION OF THE EMBODIMENTS

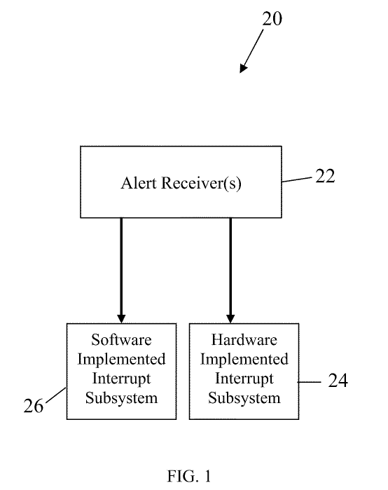

An audio interrupt system 20 according to one embodiment is illustrated in schematic form in FIG. 1. Audio interrupt system 20 is adapted to interrupt the music, or other audio signals, that one or more people may be currently listening to in order to allow information to be communicated to those people. Audio interrupt system 20 therefore may be applied in a wide-variety of different environments. As one illustrative example, audio interrupt system 20 may be applied to a workplace environment where employees are allowed to listen to music, noise-cancelling headphones, or other audio signals while working. At times, it may be desirable to communicate certain information to those employees, such as that they have received a telephone call, that they are being paged, that an alarm has been issued—such as a fire alarm, smoke alarm, tornado alarm, or other weather alarm—or still other types of information. Audio interrupt system 20 facilitates the communication of this information to those individuals who are currently listening to other audio signals. In general, audio interrupt system 20 operates by interrupting the audio signals that the person is listening to and, during the interruption, system 20 may provide notification to the listener that there is information to which the listener should be made aware. The manner and content of the notification can take on a wide variety of different forms, as will be discussed in more detail below. Alternatively, system 20 may interrupt the audio signals to allow notification to be provided via devices separate from system 20, such as by allowing the notification to be delivered aurally from a paging system, a person speaking, a telephone ringing, etc.

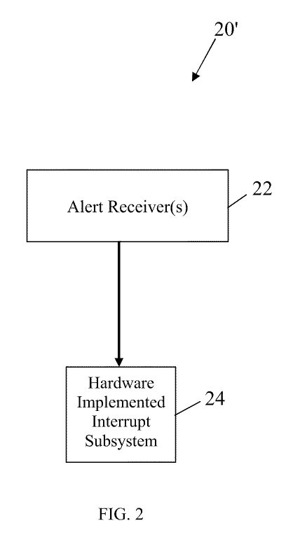

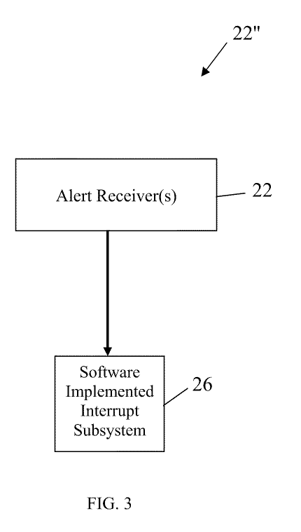

In the embodiment shown in FIG. 1, audio interrupt system 20 includes an alert receiver 22, a primarily hardware-implemented audio interrupt subsystem 24, and a primarily software-implemented audio interrupt subsystem 26. The components of audio interrupt 20 can be varied from what is shown in FIG. 1. For example, FIG. 2 illustrates an alternative audio interrupt system 20′ that does not include software implemented interrupt subsystem 26. As another example, FIG. 3 illustrates yet another alternative audio interrupt system 20″ that does not include a hardware-implemented interrupt subsystem 24. Still other variations of audio interrupt system 20 are possible. For descriptive purposes herein, it will be understood that all references below to audio interrupt system 20 will refer to any of systems 20, 20′, 20″, or other embodiments of an audio interrupt system.

Regardless of the various embodiments of the audio interrupt system, alert receiver 22 is adapted to receive information indicating that an interruption of a user's listening device is desirable. For example, alert receiver 22 may be adapted to receive information concerning a smoke alarm, fire alarm, weather alert, a mandatory building evacuation, an incoming telephone call, a page, an e-mail, or any other information that is desirably communicated to one or more individuals who may be listening to music or other audio signals. The various types of information that may desirably be communicated to such listeners will hereinafter be generically referred to as “alert information.” After alert receiver 22 receives the alert information, it passes it onto one or both of the hardware and software interrupt subsystems 24 and 26, depending on the configuration of the system, for processing in a manner to be described more below.

Alert receiver 22 may take on a wide variety of different forms. In some embodiments, alert receiver 22 may be physically separate from the structures of subsystems 24 and 26, while in other embodiments they may be physically combined into common structures. In other embodiments, there may be multiple alert receivers 22 that feed into one or more of subsystems 24 and 26. In still other embodiments, there may be more than one of the hardware and/or software subsystems 24 and 26. Other variations are also possible. Whatever the number of alert receivers 22, they may include off-the-shelf electrical or electronic devices—such as a weather radio, a computer keyboard, a computer mouse, a telephone system, a paging system, a smoke alarm, a fire alarm, or other devices—or they may include custom-designed structures adapted to receive an input indicating that one or more people should be alerted to one or more pieces of information. In other embodiments, alert receiver 22 may include a combination of off-the-shelf and custom-designed components that interact with each other. As but one example, alert receiver 22 may comprise a custom-designed electrical or electronic device adapted to receive alert information from a plurality of off-the-shelf components, such as a device that is in communication with both a fire alarm system and a weather alert system. The electrical device may be in communication with additional or different structures as well.

In other embodiments, alert receiver 22 may include one or more computers that execute software that enable a user of one or more of the computers to input alert information, such as via a computer mouse, keyboard, or other means. For example, if alert receiver 22 includes one or more computers, a receptionist might input information into the computer indicating that the person has just received a phone call, or that one or more people are being paged. Alternatively, the computer may execute software that receives alert information without the necessity of human intervention. Such software may be configured to receive alerts regarding incoming e-mail; it may be configured to allow a computer to communicate with a phone system for receiving incoming call information; it may be configured to allow a computer to communicate with other alerting devices, such as a paging system and/or weather, smoke, or fire alarms; or it may be configured in other manners.

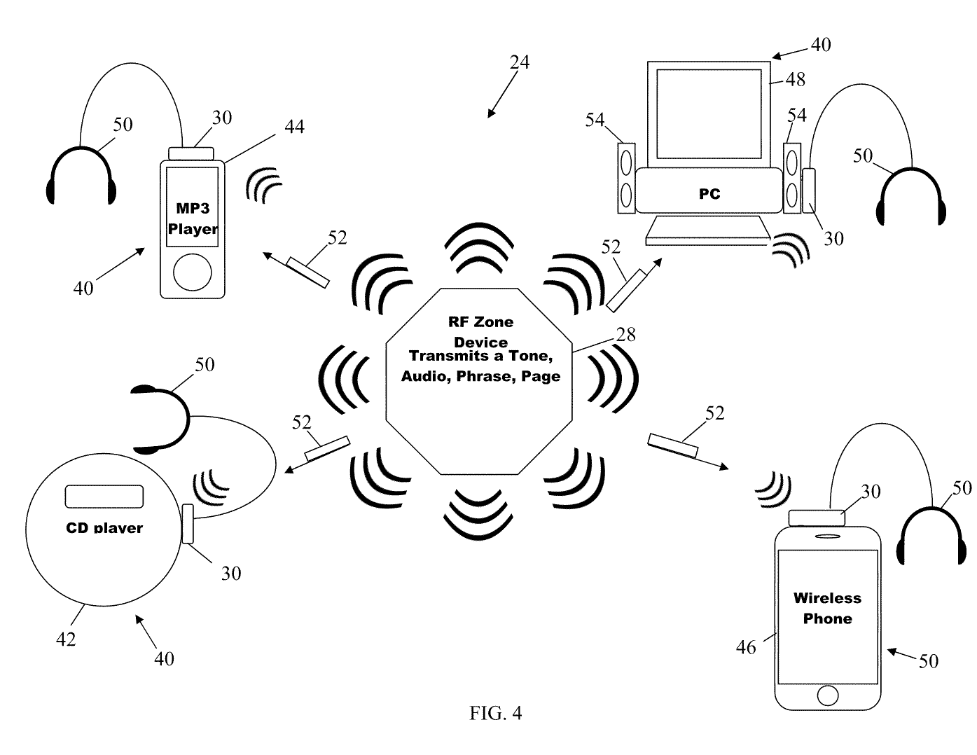

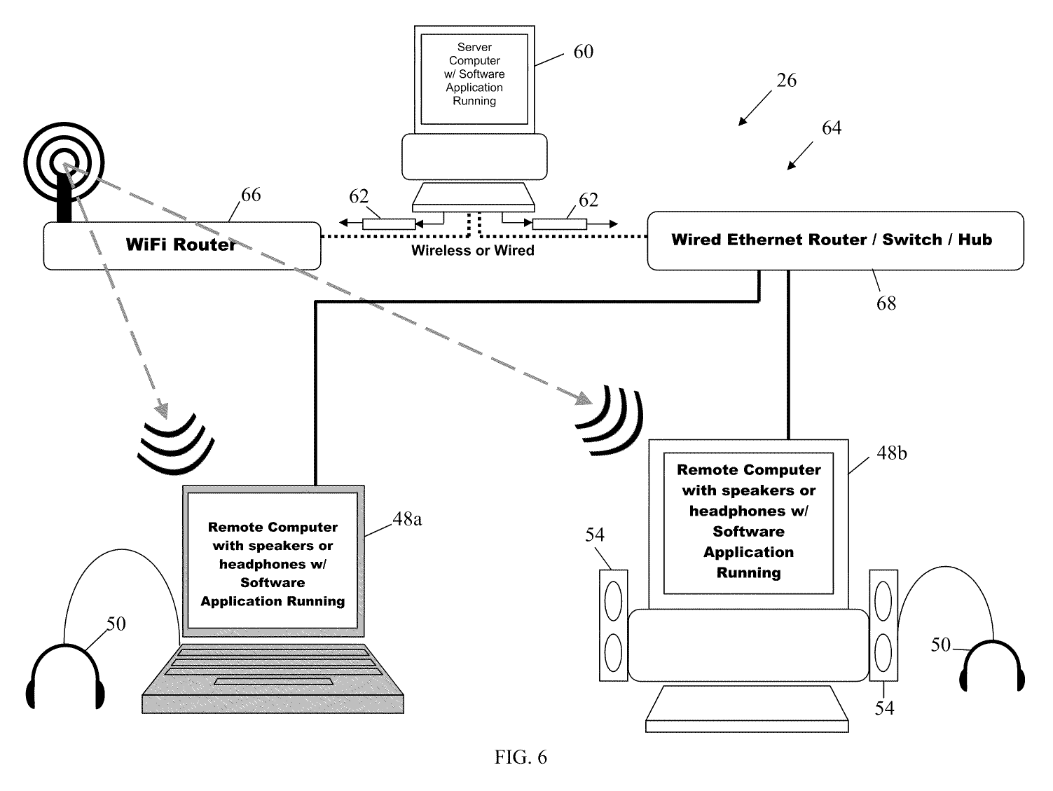

Regardless of the various configurations in which alert receiver 22 may manifest itself, alert receiver 22 sends an alert message to either or both of hardware subsystem 24 and software subsystem 26. In those embodiments where there are more than one hardware subsystem 24 or software subsystem 26, alert receiver 22 may send the alert message to these additional subsystems 24 or 26. The manner in which subsystems 24 and 26 may be implemented can vary widely. One illustrative example of each is illustrated in FIGS. 4 and 6, which will be described more below.

A primarily-hardware implemented alert subsystem 24 is illustrated in FIG. 4. While subsystem 24 will be referred to herein as being hardware implemented, or primarily hardware implemented, this is not meant to imply that subsystem 24 must exclude software components. Rather, the term “hardware implemented” is merely intended to convey the fact that subsystem 24 includes more hardware components than software subsystem 26. Similarly, the term “software implemented” is not intended to imply that subsystem 26 must exclude hardware components, but rather that software implemented subsystem 26 includes more software than hardware implemented subsystem 24.

Hardware subsystem 24 includes one or more transmitters 28 and one or more audio controllers 30. Transmitters 28 act as a hub that communicates with alert receiver 22 and that, in response to receiving one or more alert messages from alert receiver 22, transmits wireless control signals 52 to audio controllers 30 (FIG. 4). The wireless transmission may occur by way of radio frequency communications (RF), or by other means. Further, while transmitters 28 are referred to herein as transmitters, this label is not meant to exclude the possibility that transmitters 28 may also be transceivers, in which case they are adapted to receive wireless signals in addition to transmitting them. The wireless signals that may be received may come from audio controllers 30, such as will be described in greater detail below. The use of the term “transmitter” herein will therefore be understood to be broad enough to encompass devices that only transmit signals, as well as devices that both transmit and receive signals.

The control signals 52 transmitted by transmitters 28 to audio controller 30 may be the same as the alert message it receives from alert receiver 22, or it may be modified signal based upon the information contained within the alert message. Transmitters 28 may comprise one or more antennas positioned within a desired environment where audio control system 20 is to operate. The antennas may be positioned indoors, outdoors, or both. If used in an office environment, transmitters 28 may be positioned on or within the ceiling, or at any other suitable location that enables them to transmit signals over a desired coverage area without undue interference.

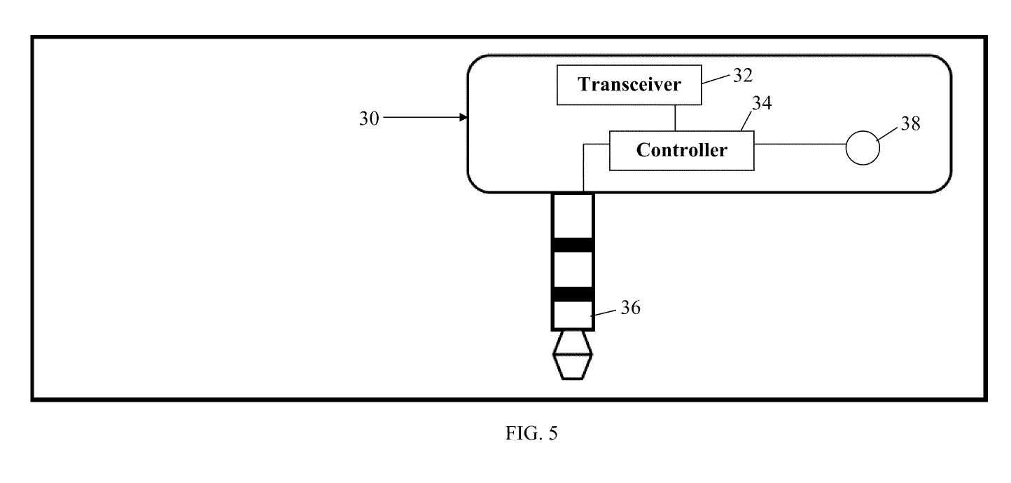

Audio controllers 30 receive the control signals 52 transmitted from one or more transmitters 28. One example of an audio controller 30 is illustrated in more detail in FIG. 5. In the embodiment shown in FIG. 5, audio controller 30 includes a transceiver 32, a controller 34, an audio plug 36, and an audio socket 38. Transceiver 32 is adapted to receive the wireless control signals 52 broadcast by transmitter 28, and is further adapted to transmit signals to other devices, such as signals that may be sent back to transmitter 28. It will be understood by those skilled in the art that transceiver 32 may replaced, in some embodiments, by a receiver that is only capable of receiving signals, and not capable of transmitting them. Reference to the term “transceiver” herein shall therefore be understood as being broad enough to encompass devices that only receive signals, only transmit signals, or that both transmit and receive.

Audio plug 36 of audio controller 30 (FIG. 5) may be any of a variety of conventional or non-conventional audio plugs. For example, plug 36 may be an RCA plug, an EIAJ RC-5320A plug, an RJ (registered jack) plug for use with telephones, a TRS (tip, ring, sleeve) audio jack of any diameter, or any other type of plug that may be inserted into a corresponding socket on an audio player 40. Plug 36 may alternatively be a plug that fits into a socket on audio player 40 that allows for the audio player 40 to be controlled in some manner, such as a socket that allows music files to be transferred to the audio player 40, or other types of sockets that enable control of the audio player 40.

Several examples of different types of audio players 40 that may be used with audio interrupt system 20 are illustrated in FIG. 4. These include a CD player 42, an MP3 player 44, a wireless phone 46 such as cell phone, and a computer 48. These examples are not meant to be exhaustive, and other types of audio players 40 may be used with the audio interrupt systems 20, such as, but not limited to, wired telephones, noise-cancellation devices, record players, and others. In general, any type of audio player 40 may be used with audio controller 30 that includes one or more sockets that allow audio controller 30 to control the audio signals that are delivered to the associated aural transducer for being heard by a listener.

Thus, for example, audio plug 36 may be inserted into a headphone socket (not shown) on CD player 42, or MP3 player 44, or wireless phone 46, or computer 48, or on any other type of audio player 40. Alternatively, audio plug 36 may be inserted into a speaker socket on an audio player 40, such as, but not limited to, one or more speaker sockets on a boom box, a record player, a computer, or any other device that plays music, or other audio signals, via one or more speakers. As yet another alternative, audio plug 36 may be inserted into a socket on a telephone base station, or other telephonic device. Still other variations are possible.

Audio players 40 may each include some form of an audio storage unit that stores the audio information that may be played on the player 40. The form of the audio storage unit varies widely depending upon the specific type of audio player. For example, the audio storage unit for CD player 42 will be a CD, The audio storage unit for an MP3 player 44 will likely be a hard drive, a flash drive, or some other form of non-volatile electronic memory that is capable of storing music files that can be read and played by MP3 player 44. If audio player 40 is a computer, multiple different types of audio storage units may be included on the computer, including the computer's hard drive, its CD-ROM drive, a thumb drive with flash memory, RAM, and other types of storage units. In some instances, audio player 40 may not include any audio storage unit, but instead may deliver audio signals to a user that are either received from another device or generated internally within the device. A telephone is but one example of the former, and noise-cancelling headphones are but one example of the latter.

As noted above, audio controllers 30 further include an audio socket 38. Audio socket 38 is adapted to matingly receive a corresponding audio plug from a transducer adapted to convert electrical audio signals into acoustical signals able to be detected by the human ear. Examples of such transducers include headphones 50 (FIG. 4), speakers 54 (FIG. 4), or other devices. Thus, for example, audio controllers 30 may be adapted to receive in socket 38 the audio plug from a conventional set of headphones 50. Or audio controllers 30 may be adapted to receive in socket 38 the audio plug from one or more speakers 54. Or audio controller 30 may be adapted to receive still other devices in socket 38. Audio controller 30 may further be adapted to include multiple sockets 38 of different types and/or sizes in order to be compatible with different types of audio transducers, thereby enabling audio controller 30 to be used in a wider variety of applications.

Audio controllers 30 are designed to pass the audio electrical signals they receive from plug 36 (when inserted into an audio player 40) onto socket 38 in the absence of receiving any control signals 52 from transmitter 28. That is, when audio controller 30 does not receive a control signal 52 from one or more transmitters 28, audio controller 30 passes the electrical signals received from plug 36 to socket 38 without substantial, or any, modification. As a result, if audio plug 36 of audio controller 30 happens to be plugged into CD player 42, and the headphones 50 for the CD player 42 are plugged into socket 38 of audio controller 30, the user of CD player 42 will hear the music of the CD player on the headphones 50 in the same manner as he or she would if the headphones had been plugged directly into the headphone socket of CD player 42. Thus, audio controllers 30 act as a sort of intermediary device between the audio players 40 and the accompanying transducer (e.g. headphones 50). When no control signals 52 are received from transmitter 28, then audio controller 30's role as an intermediary is to simply pass the audio signals from the player 40 to the associated transducer. However, when a control signal is received, then audio controller's role as an intermediary is to modify the transmission of the audio signals received at plug 36 to socket 38 in some fashion. The various modifications are discussed more below.

In one embodiment, audio controllers 30 may be configured to terminate the electrical connection between audio plug 36 and socket 38 upon the receipt of a control signal 52 from transmitter 28. In such a situation, if a person is listening to music on headphones 50 that are inserted into audio socket 38 of audio controller 30, the receipt of the control signal 52 will cause audio controller 30 to stop transmitting the musical (or other type) signals from audio player 40 to headphones 50. Thus, the person listening to headphones 50 will have his or her music interrupted when audio controller 30 receives the appropriate control signal from transmitter 28. This interruption in the music being played on headphones 50 should enable the individual to hear other sound around him or her, such as the sound of a fire alarm, smoke alarm, weather alert, a page, a telephone ringing, or any other information that may be useful for the individual to hear.

The interruption of the audio signals transmitted to socket 38 upon the receipt of a control signal 52 is carried out by controller 34. Controller 34 may take on a wide variety of different forms. In its simplest embodiment, it may simply comprise a switch in communication with transceiver 32. In such an embodiment, the switch electrically couples plug 36 to socket 38 when no control signals 52 are received by transceiver 32, and electrically decouples plug 36 and socket 38 when a control signal 52 is received. In other embodiments, controller 34 may take on more complex forms, including a microprocessor, a set of discrete logic, a field programmable gate array, an application specific integrated circuit, or any other electronic device or combination of electronic devices, suitable for carrying out the functions described herein, as would be known to one of ordinary skill in the art.

In one embodiment, controller 34 may be designed to electrically decouple plug 36 from socket 38 for a preset amount of time after receiving the control signal 52 from transmitter 28. Such a decoupling may occur for a preset amount of time that is deemed sufficient for the user of audio controller 30 to receive and/or listen to the information that is intended to be communicated to him (such as the fire alarm, a notice of a phone call, an email alert, etc.). Such preset amounts of time may be in the range of several seconds to over ten seconds, although other amounts of time may be implemented. In other embodiments, the length of time which controller 34 disconnects plug 36 from socket 38 may be variable and depend upon the type of control signal 52 received. That is, audio system 20 may be configured such that transmitter 28 is capable of transmitting different types of control signals 52, such as different messages indicative of different types of information that is intended to be communicated to the user of audio controller 30. For example, different control signals 52 may be transmitted by transmitter 28 for phone calls, pages, alarms, emails, etc. Depending upon the type of control signal 52, the electrical decoupling of plug 36 from socket 38 may vary for different amounts of time.

In still another embodiment, the amount of time of the electrical disconnect between plug 36 and socket 38 may be specified by control signal 52, regardless of the specific type of control signal 52. That is, control signal 52 may contain a data field indicating the length of time for the audio interrupt. In such an embodiment, controller 34 is adapted to read this data field and carry out the disconnect for the specified amount of time.

In addition to, or in lieu of, interrupts that cause a complete disconnection between plug 36 and socket 38, audio controllers 30 may be configured to respond to control signals 52 in other manners, such as by muting the amplitude of the electrical signals received at plug 36 before passing them onto audio socket 38. Such muting would enable the listener of the audio player 40 to continue to listen to the music (or other audio sounds) being played on audio player 40, but the volume of the music (or other sounds) would be reduced, thereby facilitating aural communication with the listener. When configuring the audio interrupt system to carry out this muting, the muting may occur automatically upon receipt of a control signal 52, or it may occur only if control signal 52 contains a command for muting, or it may occur based on other criteria.

In still other variations, audio controller 30 may be configured, in addition to either muting the signal from plug 36 or decoupling it from socket 38, to pass an extraneous audio signal onto socket 38 that originates from a source other than audio player 40. The source of the extraneous audio signal may be from a memory contained within audio controller 30; or it may come from control signal 52; or it may come from a stream of signals transmitted wirelessly by transmitter 28 to audio controller 30; a radio signal; or it may come from other sources. The content of the extraneous signal can be varied in different manners, and may be, in some embodiments, specifically tailored to the type of audio interrupt that is occurring. For example, if transmitter 28 is transmitting a control signal 52 indicating that a fire alarm has gone off in the building or other vicinity, the extraneous audio message may be a recording of a human voice saying “fire alarm,” or some other words indicating that a fire alarm has just gone off. The recording may be stored in any suitable format on any suitable media contained with audio controller 30, or, as noted above, may be transmitted wirelessly by transmitter 28 to audio controller 30. In addition to human voices, the extraneous audio signal may alternatively include a computer-synthesized voice, or it may include sounds that include no voices of any kind. Whatever the extraneous audio signal, it is passed onto socket 38, into which headphones 50 or some other type of audio transducer are inserted. The extraneous message is thus heard by the user of the audio player 40 to which audio controller 30 is coupled.

In still other embodiments, transmitter 28 and audio controller 30 may be configured to feed audio information to headphones 50, or other audio transducer, that is not pre-recorded. For example, transmitter 28 and audio controller 30 may be configured to establish a wireless communications channel therebetween, which may be either a one-way communication channel from transmitter 28 to audio controller 30, or a two-way communication channel between transmitter 28 and audio controller 30. Such a communication channel would allow, for example, a receptionist or other person to have their voice signals transmitted to socket 38, and from there to the associated headphones 50 or other type of audio transducer. In such an embodiment, the music to which a person might be listening on audio player 40 would be interrupted and the sound of a person speaking live to them could be heard. Thus, for example, a receptionist might be able to announce to the person that he or she has a telephone call on a particular line. Or he or she might tell the listener that he or she is being paged. Still other types of information might be aurally communicated to the listener, If audio controller 30 and transmitter 28 establish two way communications and audio controller 30 is equipped with a microphone, the listener could talk into the microphone and respond to the person to whom he or she is receiving the message from.

In some embodiments, each audio controller 30 includes at least one address that is stored internally within audio controller 30 by any suitable means, such as, but not limited to, flash memory, ROM, EEPROM, or other means. In such embodiments, control signals 52 from transmitters 28 include one or more addresses that indicate which audio controllers 30 are intended to respond to the control signal 52. These addresses may be received from alert receiver 22, or they may be forwarded to transmitter 28 by other means. The audio controllers 30 that have stored addressed are configured to, via controller 34, check the address or addresses contained within control signal 52. If the address or addresses of control signal 52 match at least one of the addresses stored within audio controller 30, then controller 34 will proceed to modify the electrical signal being passed from plug 36 to socket 38, such as by terminating, muting, playing a pre-recorded message, playing a live message, playing a radio signal, or any combination of these or the other potential responses discussed above. Audio controller 30 may store multiple addresses it is responsive to for multiple reasons, including, but not limited to, responding to special addresses that designate one or more particular groups of controllers 30 of which it is a part. Audio controllers 30 may also be responsive to control messages 52 that specify a range of addresses, rather than a list of one or more specific addresses. It will also be understood that the term “address” as used herein is not meant to be limited to digital signals, but instead may also include analog signals. An “address,” as used herein, may therefore refer to a specific frequency to which an audio controller is responsive, or a specific type of carrier wave modulation, or any other types of analog or digital signals that enable hub 28 to target individual ones, or groups of ones, of audio controllers 30

The use of addresses within control signals 52 enables audio interrupt system 20 to tailor the interrupts to specific individuals. In that manner, if a particular employee, for example, receives a phone call, transmitter 28 can send out a control signal that will only be processed by the audio controller 30 that is being used by the person who received the phone call, and will be ignored by all of the other personnel who may be using other audio players 40. This allows audio interruptions to be focused on specific individuals, rather than entire groups. Control signals 52 may also be constructed to include more than one address, thereby enabling subsets of individuals to be notified of alert information. Still further, audio interrupt system 20 may be configured to include a special universal address that all of the audio controllers 30 respond to, or other special addresses that designate specific groups of audio controllers 30. Such addresses allow groups of individuals to be targeted for audio interruption. A database may be maintained at alert receiver 22, or at any other suitable locations, that correlates specific individuals, such as employees, to the addresses assigned to audio controllers 30, thereby allowing audio interrupt system 20 to interrupt selected individuals.

While FIG. 4 illustrates audio controllers 30 positioned between headphones 50 of various associated audio players 40, it will be understood that audio controllers 30 may be located elsewhere. As one example, audio controllers 30 may be positioned such that plug 36 inserts into a speaker port on any of an amplifier, tuner, receiver, television, computer, or other device that sends electrical audio signals to a speaker. When so positioned, the speaker cable is inserted into socket 38. Upon receiving a control signal 52, the audio controller 30 will thus terminate or mute the speakers of the audio player 40, and/or deliver a different audio message, whether pre-recorded or otherwise, to the speaker plugged into socket 38. Thus, for example, an audio controller 30 could be positioned between one of the speakers 54 of FIG. 4 and computer 48. Such an audio controller 30 would disable the speaker 54, or mute it, or add an audio signal to it, upon receipt of control signal 52.

In other embodiments, audio controllers 30 may be modified such that they are integrated directly into audio players 40, headphones 50, or one or more speakers 54. When integrated into any of these various devices, plugs 36 and sockets 38 of audio controllers 30 may be omitted while audio controller 30 still retains the function of interrupting the music or other audio signals which a person is listening to upon receipt of one or more control signals 52. When integrated into headphones or other devices, audio controllers 30 may respond to all control signals 52 broadcast by transmitter 28, or, in other embodiments, they may only respond to those control signals 52 containing one or more addresses that are specific to that particular audio controller 30.

Audio controllers 30 may be powered by any conventional means, including either a rechargeable battery or a non-rechargeable battery. In other embodiments, audio controllers 30 may include an electrical cord and plug for inserting into an electrical outlet to thereby receive electrical power. In some instances, audio controller 30 may be configured to draw its power from the audio player 40 to which it is associated. In still other embodiments, audio controller 30 maybe solar powered, motion-powered, or powered by other means.

Audio controllers 30 may also be modified to include one or more displays that allow information to be displayed thereon, such as a liquid crystal display, or other type of display. In response to control signals 52 being received from transmitter 28, audio controllers 30 could respond by displaying information on the display. The displayed information may include text that described the nature of the alert (e.g. “fire,” “page,” “phone call,” etc.). Alternatively, the text might include the content of an e-mail, or other information. Still further, audio controllers 30 might be equipped with a sound-producing mechanism, such as a speaker or other means, that emitted a sound in response to control signal 52, either separate from, or in conjunction with, information displayed on the display. Such sound-emitting embodiments of audio controller 30 may also be practiced that do not include any display on them. The sound that is emitted may include a simple beeping sound, or it may include voice instructions, or it may include any other suitable audio information.

As was discussed above, audio controllers 30 may be configured, in some embodiments, to include two-way communication with transmitters 28. In such embodiments, audio controllers 30 may include a microphone, and transceiver 32 may allow voice sounds spoken into the microphone to be broadcast back to transmitter 28, which may then pass them to alert receiver 22, or to any other desirably person or entity. In some embodiments, audio controllers 30 may also be configured to communicate other information back to transmitters 28 besides voice signals generated from a microphone. Such other information may include one or more messages indicating to transmitter 28 that a particular audio controller 30 is currently in use. Transmitter 28 may then pass this information onto alert receiver 22, or any other suitable device. For example, this information may be passed onto one or more computers that can be directed to display a list of which personnel are currently using an audio controller 30 and which people are not. Audio interrupt system 20 can also be configured to check first to see if a particular audio controller 30 is currently being used before transmitting control signal 52. If the particular audio controller or controllers 30 are not being used, then audio interrupt system 20 may be configured to not send control signal 52, and may instead provide notification to the relevant person or persons that no audio interrupt was generated. Alternatively, audion interuppt system 20 may attempt to transmit information to the person or persons using audio controllers 30 by other means, such as by sending them an e-mail, telephoning them, etc. Other variations are also possible.

When audio controllers 30 are equipped with transmitting capabilities, audio interrupt system 20 may also be adapted, in some embodiments, to allow tracking—such as at transmitters 28, server 60 (discussed below), or other locations—to be performed that monitors which audio controllers 30 are in use. The monitoring takes place by way of one or more signals transmitted from audio controllers 30 to transmitters 28, server 60, or some other receiving structure that uses the signals to monitor the usage of audio controllers 30. Audio controllers 30 may further be equipped with GPS receivers that determine the location of the audio controllers 30 and broadcast that location information to the tracking structure. Such location information would allow monitoring, not only of the usage of the audio controllers 30, but also the location of such use. Such information may be valuable in a variety of different situations, including, but not limited to, emergency situations where it may be important to know where individuals are currently located, such as in a fire, tornado, terrorist attack, etc. By monitoring the location of the audio controllers 30, it may be possible to determine whether the personnel using the controllers 30 are reacting appropriately to the alert information that triggered the audio interrupt. In some embodiments, audio controllers 30 may include one or more buttons, or other data input means, that allow the user of the controller 30 to transmit data back to the hub. The type and purpose of such data is not limited, and may include information indicating one or more acknowledgements, as well as other information.

Audio controllers 30 may also be equipped with motion-detecting sensors that detect the physical movement of audio controllers 30. When so equipped, audio controllers 30 would be configured to transmit information back to transmitters 28, or other structures, indicating the movement status of audio controllers 30. Such information may be useful in a variety of different situations. For example, in the event of an emergency, one or more signals coming from audio controllers 30 that indicated that there had been no movement would likely indicate that the user of the audio controller 30 was not responding properly to the emergency alert. Re-broadcasting of the control signals 52 might then be warranted, or any other suitable measures might be taken to ensure that the emergency alert information was effectively communicated to the user of the audio controller 30.

FIG. 6 illustrates a diagram of one embodiment of a primarily software implemented audio interrupt subsystem 26. Software subsystem 26 includes a server computer 60 with interrupt software running on it that carries out several of the functions of audio interrupt system 20. It will be understood by those skilled in the art that server 60 may be replaced by a personal computer (PC), or other types of computers capable of carrying out the functions described herein. Further, as will be discussed in greater detail below, server 60 may be used in conjunction with a primarily-hardware implemented interrupt subsystem 24, although its description below will mainly be in conjunction with primarily software-implemented interrupt subsystem 26.

Server 60 may be in communication with one or more physically separate alert receivers 22, or alert receiver 22 may be partially or wholly incorporated within server 60 as software. That is, for example, one or more of a smoke alarm, fire alarm, weather alert systems, a paging system, and/or a telephone system may feed directly into server 60. For those embodiments of audio interrupt system 20 that generate audio interrupts for the receipt of email, server 60 may execute the software that runs the email systems. Other variations are also possible.

The interrupt software executed on server 60 checks for incoming alerts that indicate one or more audio interrupts should take place. When such an alert is received, server 60 sends out a control signal 52 that may take the form of data packet 62. In this manner, server 60 acts as a hub for audio interrupt system 20. Data packet 62 is sent out over a computer network 64 that may take on any form, including, but not limited to, a network that is in communication with, or part of, the Internet. In the embodiment illustrated in FIG. 6, network 64 includes a wireless router 66 and a wired router 68. Network 64 need not necessarily include either or both of these. Further, network 64 may include additional routers, hubs, and/or switches beyond those illustrated in FIG. 6.

The data packet 62 transmitted over network 64 contains one or more addresses indicating the intended recipient of the data packet 62. Such recipients may be a laptop computer, such as computer 48a of FIG. 6, that is wirelessly connected to the network 64, or a computer, such as computer 48b, that is connected to network 64 by a hard-wired connection. The data packet 62 contains a command indicating that the recipient of the packet should alter the audio signals, if any, that are currently being delivered to the user of the computer, such as by way of headphones 50 connected to the computer, or by way of one or more speakers 54, or by any combination thereof. The specific manner in which the audio signals are to be altered may include termination, muting, or any of the other alterations discussed above with respect to hardware subsystem 24. Upon receiving a data packet 62 intended for it, a computer 48 will therefore react by taking one or more steps that enable information about the alert to be communicated to the user of the computer, and such steps may involve disabling, muting, or otherwise altering the audio signals that the user may be listening to.

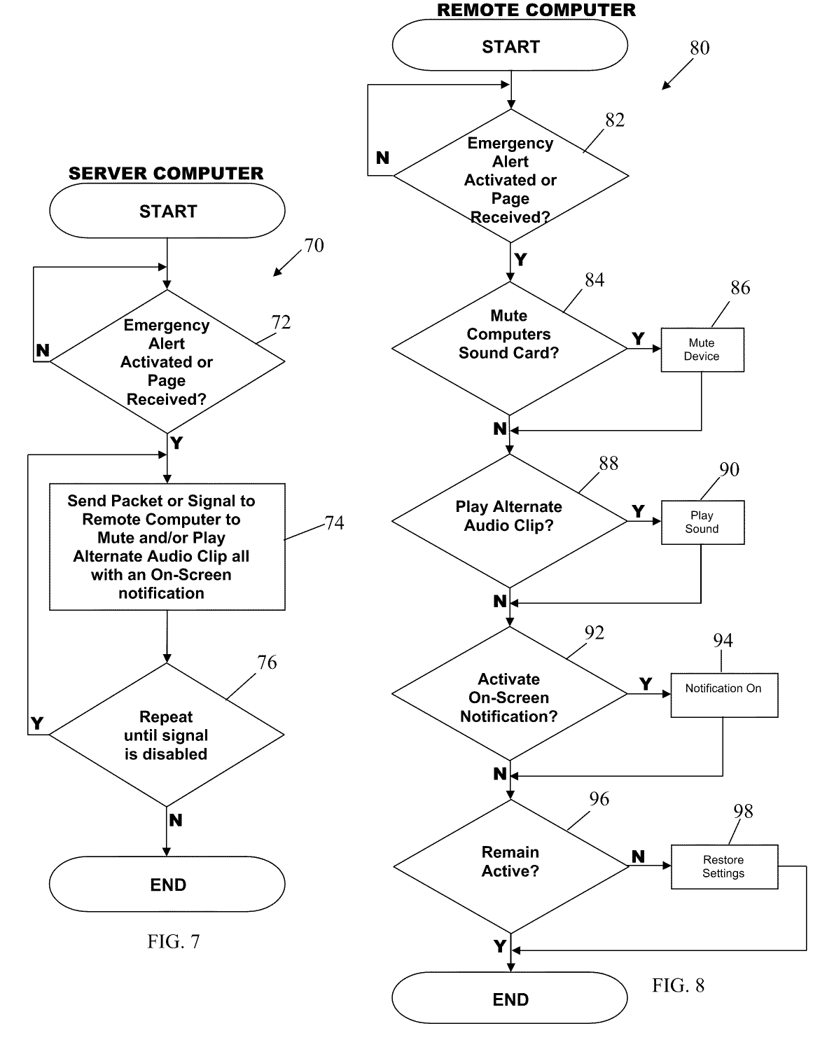

Each of server 60 and the computers 48 that are connected to network 64 operate software that enables the operation of audio interrupt system 20. One example of a process 70 that may be carried out by the software executed on server 60 is illustrated in the flowchart of FIG. 7, although it will be understood that substantial modifications to this process may be made. At step 72, server 60 checks to see if it has received an alert notification. As described above, such an alert notification may come from a wide variety of sources, including, but not limited to, alert receiver 22, alarms, pages, emails, telephone calls, or other sources. If server 60 does not detect an alert, it returns back to step 72 and checks again for an alert. This repetitive monitoring continues until an alert is received. Once an alert is detected, server 60 proceeds to step 74, where it sends out data packet 62 onto network 64. The data packet 62 may include information specifying one or more types of actions that the recipient of the data packet 62 should take upon receipt. Some of these possible types of actions include muting a sound card, playing an alternate audio clip, providing an on-screen notification, and others. After transmitting the data packet 62 at step 74, server 60 proceeds to step 76, where it continues to transmit the data packet 62 (or other type of signal) onto network 64 until the alert terminates. After the alert ends, server 60 will start process 70 over again and continue to monitor for additional alerts. While not illustrated in FIG. 7, it will be understood that multiple instances of process 70 may be carried out simultaneously, or nearly simultaneously, on server 60 such that, for example, server 60 may be transmitting data packets to one particular computer 48 at steps 74 or 76, while also transmitting different data packets to a different computer 48, or while also listening for other incoming alerts.

The software executed by each of computers 48 may carry out the process 80 illustrated in FIG. 8, although substantial modifications may be made. At step 82 of process 80, computer 48 checks to see if it has received one or more of data packets 62 that are addressed to it. If not, computer 48 repeats step 82 and continues to check for incoming data packets 62 until one is received. When such a data packet 62 is received, computer 48 proceeds to step 84. At step 84, computer 48 analyzes the content of the data packet 62 to check and see if it contains instructions to mute the sound card contained within computer 48. If it does, computer 48 proceeds to mute the sound card at step 86, and thereafter proceeds to step 88. If it does not, computer 48 skips muting the sound card and proceeds to step 88.

At step 88 (FIG. 8), computer 48 checks to see if the data packet 62 contains an instruction to play an alternate audio clip. If it does, computer 48 proceeds to step 90 and plays the alternate audio clip, thereafter proceeding to step 92. If it does not, computer 48 skips step 90 and proceeds to step 92. The alternate audio clip that may be played by computer 48 at step 90 may take on any of the forms discussed above with respect to audio controller 30, or other forms. As but some examples, the alternate audio clip may be a pre-recorded message of a human voice indicating the nature of the alert received, such as “fire alarm,” “tornado alert,” etc. Data packet 62 may, in some embodiments, indicate not only that an alternate audio clip should be played, but also may include information identifying a specific type of alternate audio clip to be played. In that manner, computer 48 may react to data packet 62 by playing different audio clips, depending upon the specific type of alert information that was received by server 60 at step 72.

At step 92 of process 80 (FIG. 8), computer 48 checks to see whether the received data packet 62 contains an instruction to provide an on-screen notification to the user of computer 48. If it does, computer 48 proceeds to provide an on-screen notification to the user at step 94. If it does not, computer 48 skips step 94 and proceeds to step 96. The particular form of the on-screen notification provided at step 94 may vary and, as with the alternate audio clips of step 90, may be selected from a plurality of different types of on-screen notifications based upon information contained within data packet 62.

At step 96 of process 80 (FIG. 8), computer 48 checks to see whether the received data packet 62 contains an instruction to continue to implement any one or more of the changes that may have been made at steps 86, 90, and/or 94. Such an instruction may tell computer 48 to wait a specified amount of time before proceeding to step 98, or it may instruct computer 48 to continue to implement the changes until another data packet 62 is received, or it may take on other forms. Regardless of form, computer 48 remains at step 96 until it is time to restore the settings that may have been changed at any of steps 86, 90, and/or 94. This step of restoration is carried out at step 98. After step 98, computer 48 returns to step 82 and process 80 begins again with computer 48 checking for additional alerts.

While process 80 as illustrated in FIG. 8 indicates that there are three potential actions that may be taken by computer 48 in response to a data packet 62, it will be understood that either a fewer or a greater number of response options may be included in process 80. Further, it will be understood that, although processes 70 and 80 have been described herein in terms of a data packet 62, these processes may utilize more than one data packet for carrying out the steps indicated. Still further, it will be understood that the reference to the term “data packet” is not meant to be limiting in terms of the manner in which information is communicated over network 64 from server 60 to computer 48, but includes any type of control signals 52. In some embodiments, the software on server 60 and computers 48 may be configured to allow voice communications (such as a telephone call) to be transmitted through server 60 to one or more particular computers 48.

As with hardware subsystem 24, software subsystem 26 may allow for two-way communication between computers 48 and server 60 with respect to audio interrupt information. That is, in addition to transmitting data packets 62 to computers 48, server 48 may also receive data back from any of computers 48 regarding the status of the computers 48. Such status may include, for example, an indication that music or other audio signals are currently being played on a particular computer, or that a particular person is logged onto a particular computer, or a combination of these, or still other information. It is also possible that, if computers 48 are equipped with a microphone, that 2-way voice communications may be established between the computer 48 and whatever voice-input device is in communication with server 60, such as a telephone, a paging system, etc.

If computers 48 include a microphone, they may also be configured to alter the music being played on associated headphones 50 in response to ambient noise. That is, computers 48 may be programmed to monitor the microphones to detect ambient sounds above a certain threshold level. If such a sound is detected, the computer may take any one or more of the actions identified in steps 86, 90, and/or 94 discussed above. Thus, computers 48 may be configured to respond to both ambient sounds (such as a person talking to them), as well as to data packets 62 transmitted over network 64 from server 60. It will also be understood that audio controllers 30 can also be modified to include a microphone and respond in a similar manner. That is, audio controllers 30 can be modified to interrupt the audio signals being delivered to a listener upon detecting an ambient sound that exceeds a threshold, in addition to the interrupt action it takes in response to the control signals it receives from transmitter 28.

From the foregoing description it will be apparent that both transmitter 28 and server 60 may act as a hub within audio interrupt system 20. Further, it will be understood that in some embodiments, certain components of hardware subsystem 24 and software subsystem 26 may be blended together. For example, the WIFI router 66 illustrated in FIG. 6 may, in some embodiments, act as transmitter 28. That is, WIFI router 66 may broadcast wireless data packets that are not only picked up by any computers 48 that are receptive to wireless communications, but which are also picked up by audio controllers 30 that have been adapted to respond to WIFI signals. In other embodiments, transmitter 28 may comprise one or more antennas separate from WIFI router 66 but which are still in communication with network 64. In still other embodiments, transmitters 28 may be in communication with server 60 via non-network connections.

The content of control signals 52 and data packets 62 may vary widely in the various embodiments discussed herein. In some embodiments, the content may include a digital message divided into one or more data fields that specify different types of information. In other embodiments, the control signals 52 may be analog signals. In other embodiments, the signals 52 and/or packets 62 may include nothing more than audio content that is intended to be played by the associated audio player 40, such as a wave file (.wav).

It will be understood by those skilled in the art that the various embodiments described herein could be modified such that the transmission of control signals 52 or data packets 62 was carried out by not sending one or more signals when such signals would otherwise be expected. That is, audio interrupt system 20 could be modified such that the hub (transmitters 28 or server 62 or other components) regularly transmitted signals to audio controllers 30 and/or packets over network 64 when no alert message was received. When an alert message was received, however, the modified audio interrupt system 20 would then cease to transmit such signals and/or data packets. The audio controllers 30 and/or computers adapted to respond to the alert message would then respond to the absence of signals by interrupting the delivery of the electrical audio signals to their associated transducer in the manner that has been described. It is intended that the word “transmit”, or its variants, as used herein, encompasses such situations where the absence of an otherwise expected signal is used to convey information.

While the present invention has been described herein in terms of various embodiments, it will be understood by those skilled in the art that the invention is capable of being implemented in a wide variety of other embodiments beyond those described and illustrated herein. Accordingly, the scope of the invention is intended to be limited only by the scope of the appended claims, as interpreted according to the principles of patent law, including the doctrine of equivalents.

What is claimed is:

1. An audio interrupt system comprising:
a plurality of audio players, each of said audio players adapted to generate an electrical audio signal and transmit the electrical audio signal to an associated transducer adapted to convert the electrical audio signal to an aural signal that may be heard by a listener;
a plurality of audio controllers, each said audio controller adapted to alter the transmission of said electrical audio signals from at least one of said audio players to the audio player's associated transducer; and
a hub adapted to transmit a control signal to said plurality of audio controllers whereby said control signal causes said plurality of audio controllers to alter the transmission of said electrical audio signals from said audio players to the audio player's associated transducer.

2. The system of claim 1 wherein said plurality of audio players include at least one of a computer, a compact disc player, a portable media player, a cassette player, a stereo, and a cell phone; and said transducer is at least one of a stand-alone speaker and a speaker positioned within a headphone.

3. The system of claim 1 wherein said audio players each include an audio storage unit that includes at least one of an electronic memory, a compact disc, an audio cassette, a record, and a digital versatile disc (DVD).

4. The system of claim 1 wherein the altering of the transmission of said electrical audio signals includes one of terminating said electrical audio signals and reducing an amplitude of said audio signals.

5. The system of claim 1 wherein at least one of said audio controllers further includes:
a plug for inserting into an earphone socket on said audio player;
a wireless receiver for receiving said control signal from said hub;
an earphone socket for receiving an earphone plug from one or more earphones; and
a control in communication with said plug, said wireless receiver, and said earphone socket, said control adapted to transmit said electrical audio signals from said earphone plug to said earphone socket in the absence of said control signal, and said control adapted to terminate the transmission of said electrical audio signals from said earphone plug to said earphone socket when said receiver receives said control signal.

6. The system of claim 5 wherein said at least one of said audio controllers is assigned an address, and said control for said at least one of said audio controllers is adapted to respond to said control signal only if said control signal includes an address that matches the address assigned to said at least one of said audio controllers.

7. The system of claim 1 wherein said hub includes a plurality of antennas positioned at different locations within a work environment, said hub adapted to transmit said control signals wirelessly through said plurality of antennas.

8. The system of claim 1 wherein said audio player is a computer, said audio storage unit is a memory accessible to said computer, and said hub is adapted to send said control signal to said computer over a computer network, said computer being programmed to react to said control signal by performing at least one of the following:
(a) muting a sound card on said computer;
(b) delivering an alternate audio clip to said associated transducer;
(c) providing a notification on a screen of said computer; and
(d) transmitting a telephonic audio signal to said transducer.

9. The system of claim 1 wherein said control signal includes information indicating a page, a phone call, or an emergency notification has occurred.

10. The system of claim 1 wherein said hub is adapted to transmit a plurality of types of control signals, said plurality of types of control signals causing said plurality of audio controllers to alter the transmission of said electrical audio signals from said audio players to the audio player's associated transducer in a plurality of different ways.

11. The system of claim 10 wherein said plurality of different ways includes:
terminating the transmission of said electrical audio signals from said audio players to the associated transducer;
restarting the transmission of said electrical audio signals from said audio players to the associated transducer; and
delivering an audio message to the associated transducers.

12. The system of claim 1 further including a voice activated switch incorporated into said at least one of said audio players, said voice activated switch adapted to alter the transmission of said electrical audio signals from said at least one of said audio players to its associated transducer in response to ambient sound signals exceeding a threshold sound level.

13. The system of claim 1 wherein at least one of said transducers is built into a headset and at least one of said audio controllers is also built into said headset, said headset including a cord adapted to be inserted into an electrical outlet for receiving electrical power.

14. The system of claim 1 wherein at least one of said audio controllers is adapted to transmit signals back to said hub.

15. The system of claim 14 wherein said at least one of said audio controllers is further adapted to transmit a detection message back to said hub when said audio controller detects that its associated audio player is delivering electrical audio signals to the associated transducer.

16. The system of claim 15 wherein said hub is in communication with a display device, and said hub is adapted to cause said display to display information relating to said detection message.

17. An audio interrupt unit adapted to operate in conjunction with an audio player wherein the audio player is adapted to generate an electrical audio signal for transmission to an audio transducer adapted to convert the electrical audio signal into an aural signal, said audio interrupt unit comprising:
a receiver adapted to receive a control signal containing an address; and
an audio controller in communication with said receiver, said audio controller adapted to change the aural signal in response to the control signal if the address of said control signal matches a particular address, and said audio controller further adapted to not change the aural signal if the control signal does not match said particular address.

18. The unit of claim 17 wherein said receiver and said audio controller built into a headset adapted to be worn on a head of a user.

19. The unit of claim 18 wherein said headset furthers includes a plug adapted to be inserted into the audio player.

20. The unit of claim 17 wherein said audio controller is further adapted to transmit a message to a hub, said message including an indication that said headset is currently being used by a user.

21. The headset of claim 17 wherein said audio controller is adapted to change said audio signal by doing at least one of the following: muting said audio signal, terminating said audio signal, and adding an audio message to said audio signal.

22. The unit of claim 17 wherein said audio controller includes a computer program adapted to be executed by a computer.
